(19) United States
(12) Patent Application Publication
(10) Pub. No.: US 2014/0003887 A1
(43) Pub. Date: Jan. 2, 2014

(54) HYDRAULIC CONTROL SYSTEMS FOR REGULATING TRANSFER OF BALES

(71) Applicant: Forage Innovations B.V., Maassluis (NL)

(72) Inventors: Kent Thompson, Otley, IA (US); Darin Dux, Pella, IA (US)

(21) Appl. No.: 13/918,286

(22) Filed: Jun. 14, 2013

Related U.S. Application Data
(60) Provisional application No. 61/665,753, filed on Jun. 28, 2012.

(51) Int. Cl. A01D 90/08

(52) U.S. Cl. CPC A01D 90/083
USPC 414/24.5; 414/800

(57) ABSTRACT

Hydraulic control systems for regulating the transfer of bales in an apparatus for gathering bales and methods for transferring bales that use such control systems are disclosed.

### CROSS-REFERENCE TO RELATED APPLICATION

This application claims the benefit of U.S. Provisional Application No. 61/665,753, filed Jun. 28, 2012, which is incorporated herein by reference in its entirety.

### FIELD OF THE DISCLOSURE

The field of this disclosure relates to hydraulic control systems for regulating the transfer of bales in an apparatus for gathering bales and to methods for transferring bales that use such control systems.

### BACKGROUND

Crop forages such as hay (e.g., alfalfa and/or grass hay) are periodically cut in the field, dried and compacted into bales for transport and storage of the forage material. Recent evolutions in row crop production and in technology for processing these materials have led to changes in the scale and economics of harvest and to increasing potential for harvest of crop residues like corn stover. Corn stover is also baled in the field and used as livestock feed, bedding or production of biofuels. In addition, harvest technology for cotton has been developed, that includes the step of baling the cotton in the field. Due to these relatively recent changes, the scale at which this type of harvest process is conducted in some instances is different than the traditional process. The density of the bales, in terms of the number of bales per acre, is higher in some instances, the labor availability is less in some instances and the criticality of timing is higher in some instances.

Materials may be baled into relatively large round (round in cross-section) bales which may be tied by twine, netting or plastic wrap depending on the type of material, the type of storage and the intended use of the material. The bales are typically left in the field, near the location where the bale was formed, to minimize labor and time required for the harvest process including the baling operation.

A continuing need exists for an apparatus for gathering and transporting round bales in the field after baling, one that allows the bales to be gathered relatively quickly and reliably and in a way to minimize demands on the operator, and that consistently positions the bales adjacent one another to minimize the area required for storage. A need also exists for methods for gathering bales that use such apparatus.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to an apparatus for gathering bales. The apparatus includes a bed for holding a plurality of bales, a loading assembly for lifting a bale and conveying it to the bed and a control system for regulating transfer of bales from the loading assembly to the bed by control of a first conveyor belt and/or a second conveyor belt. The loading assembly has a first arm that includes the first conveyor belt and a second arm that includes the second conveyor belt. The control system includes a hydraulic motor for rotating the first conveyor belt and/or the second conveyer belt and a hydraulic relief valve configured to actuate in response to an increase in hydraulic pressure to slow or stop movement of the first conveyor belt and/or the second conveyer belt.

Another aspect of the present disclosure is directed to an apparatus for gathering bales. The apparatus includes a bed for holding a plurality of bales. The bed includes a bed conveyor. The apparatus includes a control system for regulating the bed conveyor. The control system includes a hydraulic motor for rotating a bed conveyor and a hydraulic relief valve configured to actuate in response to an increase in hydraulic pressure to stop movement of the bed conveyor.

A further aspect of the present disclosure is directed to a method for gathering bales on an apparatus having a bed for holding a plurality of bales and a loading assembly for lifting a bale and conveying it to the bed. A first bale is loaded on the bed. A second bale is contacted using a first conveyor belt of a first arm of the loading assembly and a second conveyor belt of a second arm of the loading assembly. The first and second conveyor belts are actuated to cause the second bale to move toward the first bale. Movement of the first conveyor belt and second conveyor belt is slowed or stopped when the second bale contacts the first bale.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of an apparatus for gathering bales;

FIG. 2 is a perspective view of a portion of the apparatus showing a hydraulic cylinder for tilting the chassis of the apparatus;

FIG. 3 is a perspective view of the apparatus prior to loading a round bale;

FIG. 4 is a perspective view of the apparatus after the round bale has been loaded onto the bed;

FIG. 5 is a schematic of hydraulic circuits for controlling the conveyor belts of the apparatus;

FIG. 6 is a perspective view of the apparatus after being loaded with bales;

FIG. 7 is a perspective view of the apparatus during unloading of bales;

FIG. 8 is a side view of one arm of the loading assembly of the apparatus;

FIG. 9 is a cross-sectional view of the arm of FIG. 8 taken through line 9-9;

FIG. 10 is a cross-sectional view of the arm of FIG. 8 taken through line 10-10; and

FIG. 11 is a cross-sectional view of the arm of FIG. 8 taken through line 11-11.

Corresponding reference characters indicate corresponding parts throughout the drawings.

### DETAILED DESCRIPTION

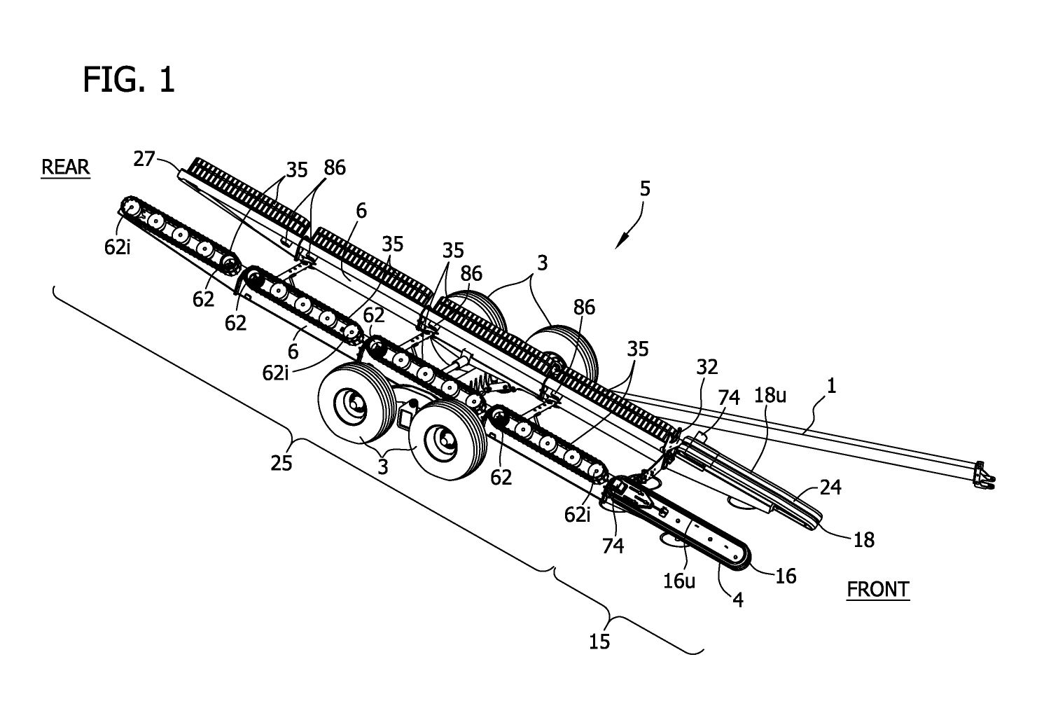

An embodiment of an apparatus for gathering round bales B is generally referred to as 5 in FIG. 1. The apparatus 5 includes a bed 25 for holding one or more bales and a loading assembly 15 for lifting a bale off the ground and conveying it to the bed. The apparatus 5 includes a tongue 1 for pulling the apparatus by use of for example, a tractor or other pulling vehicle. In some embodiments (not shown) the apparatus 5 includes its own propulsion mechanism rather than being pulled by a pulling vehicle.

Generally, the apparatus 5 is suitable for picking up cylindrical bales commonly referred to as “round” bales. Round bales are used for harvesting any material capable of being formed into a cylindrical bale such as traditional hay crops (e.g., alfalfa or grass), corn stover or other crop residues, cotton, or woody products like small diameter trees. The apparatus 5 shown in FIG. 1 is configured for loading up to 5 bales. The apparatus 5 may be modified to carry more or less bales without departing from the scope of the present disclosure.

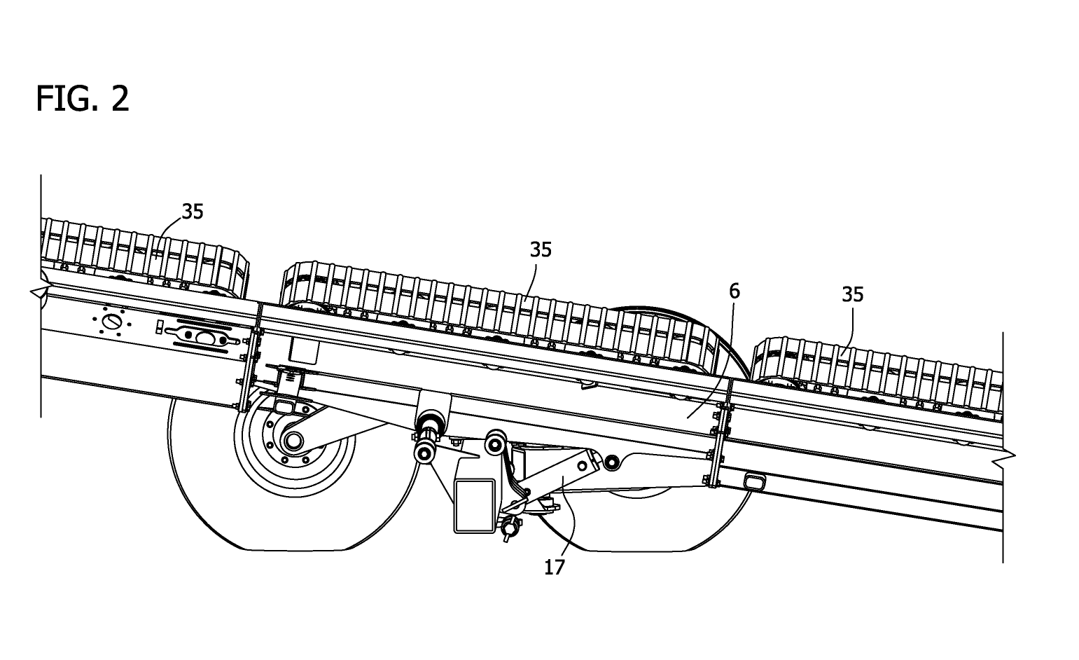

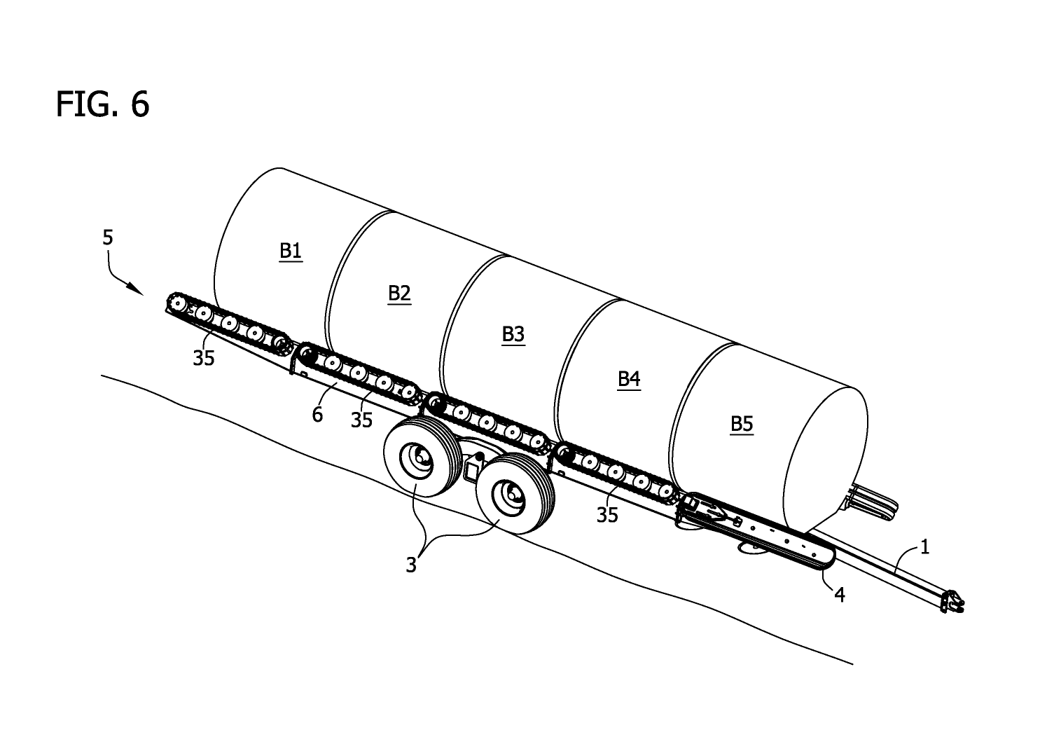

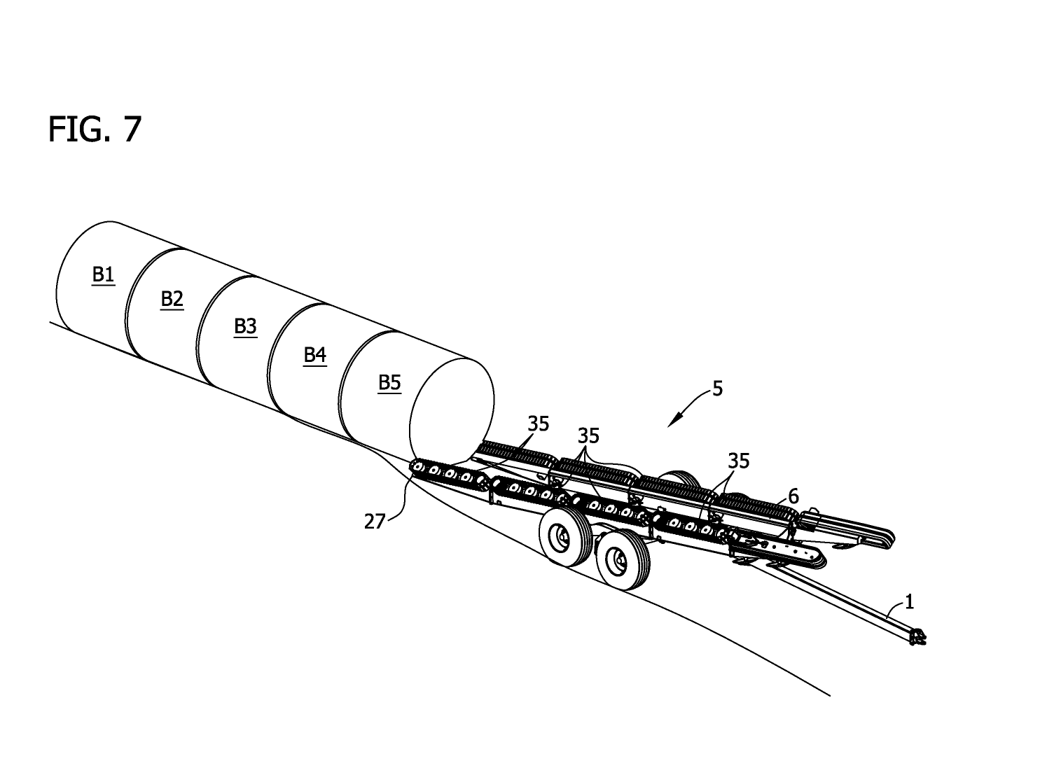

The apparatus 5 includes wheels 3 attached to a bed chassis 6. The bed 25 tilts between various positions, to a forward tilted position for loading the bales or unloading to the front, to a middle position used after bales have been loaded for transportation of the loaded bales (FIG. 6) and to a rearward tilted position for unloading and re-loading of bales to the rear (FIG. 7). The apparatus 5 may be tilted hydraulically through manual or automatic control by use of a hydraulic cylinder 17 (FIG. 2) or by any other method available to those of skill in the art. Tracks (not shown) may be used as an alternative to the wheels 3.

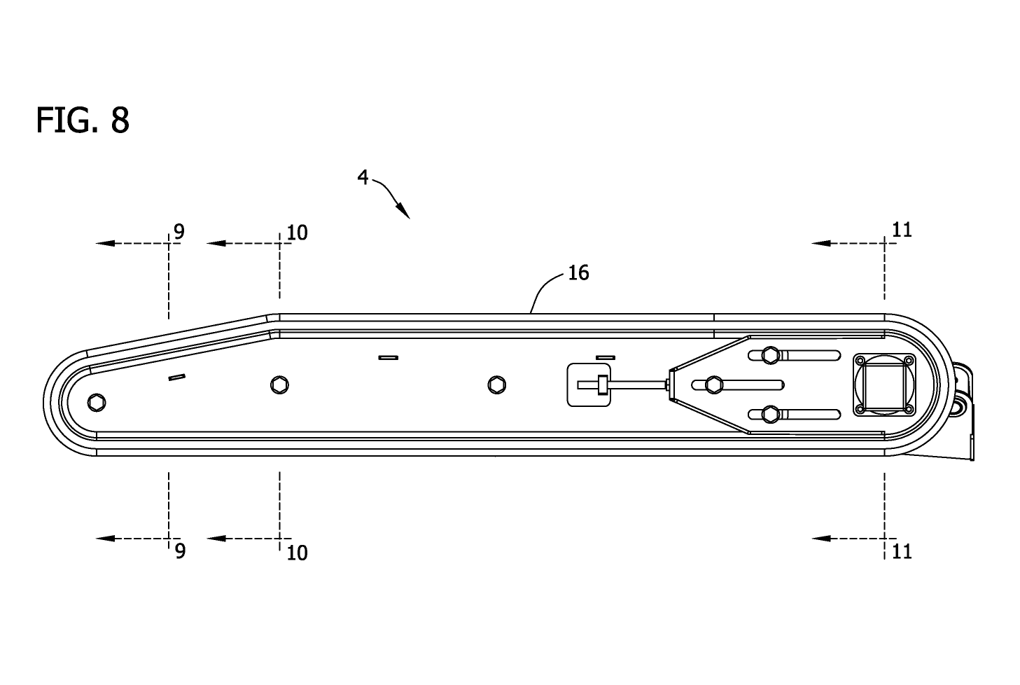

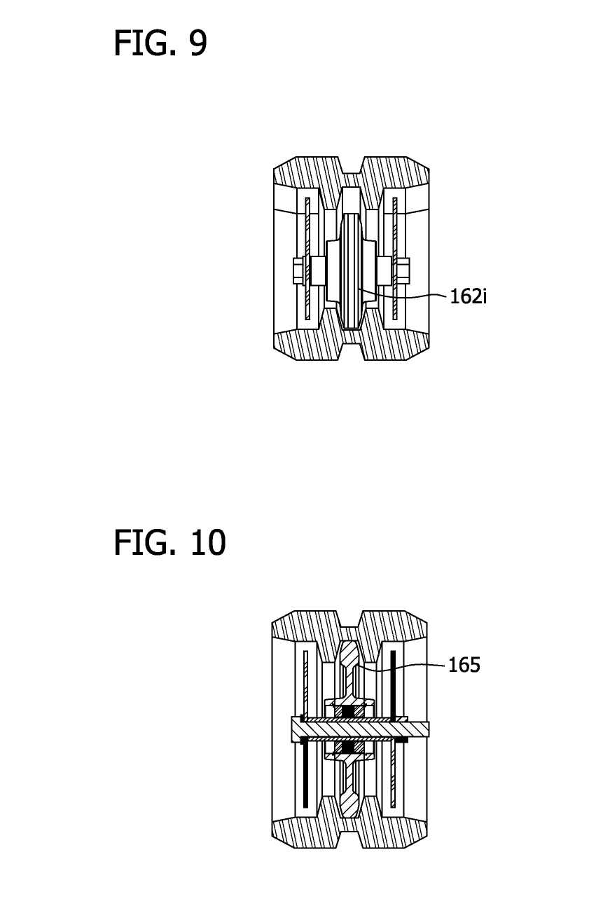

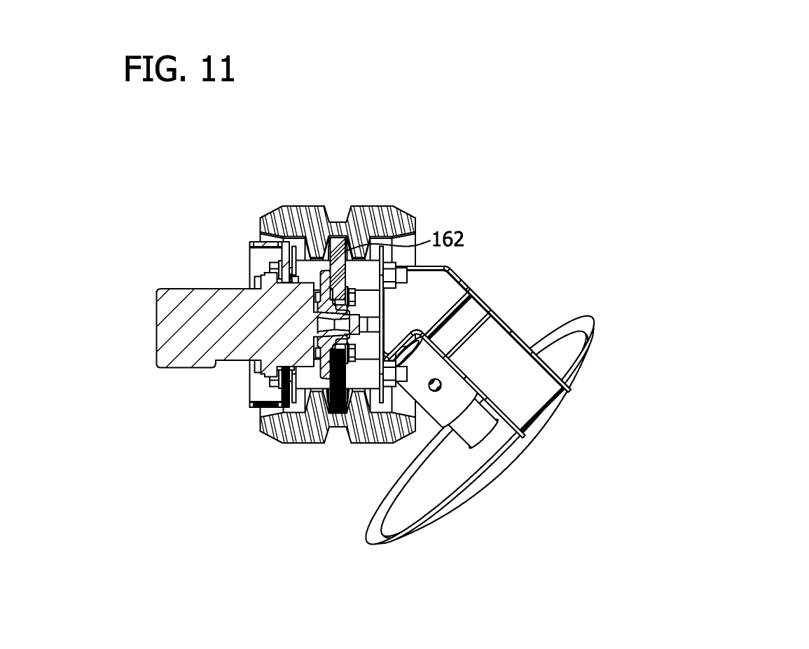

The loading assembly 15 includes two arms 4, 24 that are the first portion of the apparatus 5 to contact the bale during loading. Each arm 4, 24 includes an endless conveyor belt 16, 18. Referring now to FIGS. 8-11 in which one arm 4 is shown in detail, the endless conveyor belt 16 moves along a path between a front idler roller 162i (FIG. 9) that rotates freely and a driven rear roller 162 (FIG. 11) connected to a rotary power device such as a hydraulic motor described below. The arm 4 includes support rollers 165 (FIG. 10) positioned between the front idler roller and the drive roller.

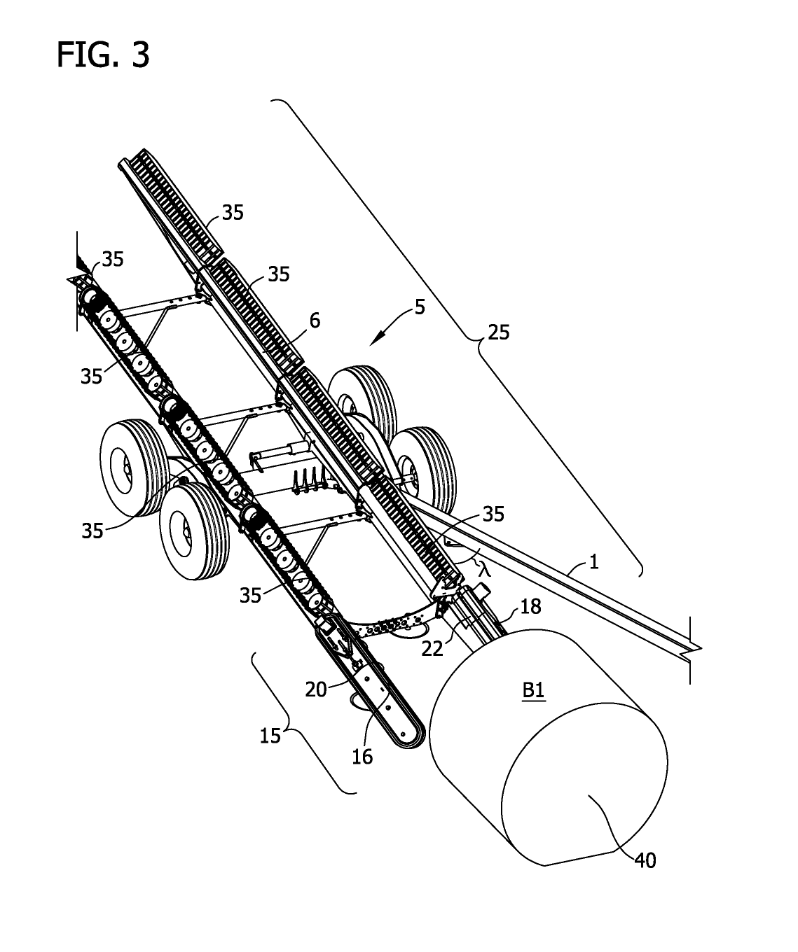

Each belt 16, 18 includes upper portions 16u, 18u (FIG. 1) that are capable of carrying the weight of a bale. The effective length of these conveyors is approximately the length of this upper surface, or the distance between the front idler roller 162i (FIG. 9) and the rear drive roller 162 (FIG. 11). The movement of the belt, around the front idler roller 162i and backward along the upper portion of the belt path, has been found to be effective to lift a bale off the ground and for simultaneously causing the bale to move toward the bed 25. This lifting and transporting action occurs after the two conveyor belts contact the bale B1 (FIG. 3).

Referring again to FIG. 1, the bed 25 includes a number of bed conveyors 35, each having an endless belt routed around a front idler roller and a rear powered roller that may be rotated to cause the belt to move which results in moving bales away from the loading assembly and toward the end 27 of the bed. Each conveyor 35 may have an effective length, the distance between the idler roller and the drive roller. This effective length may be the length of about one bale. Typical bale lengths for forage products may be between about 40 and 60 inches and bales of cotton are in the range of 100 inches in length. It should be noted that the apparatus 5 and the effective length of the conveyor belts 16, 18 are not limited by bale size or to a particular length.

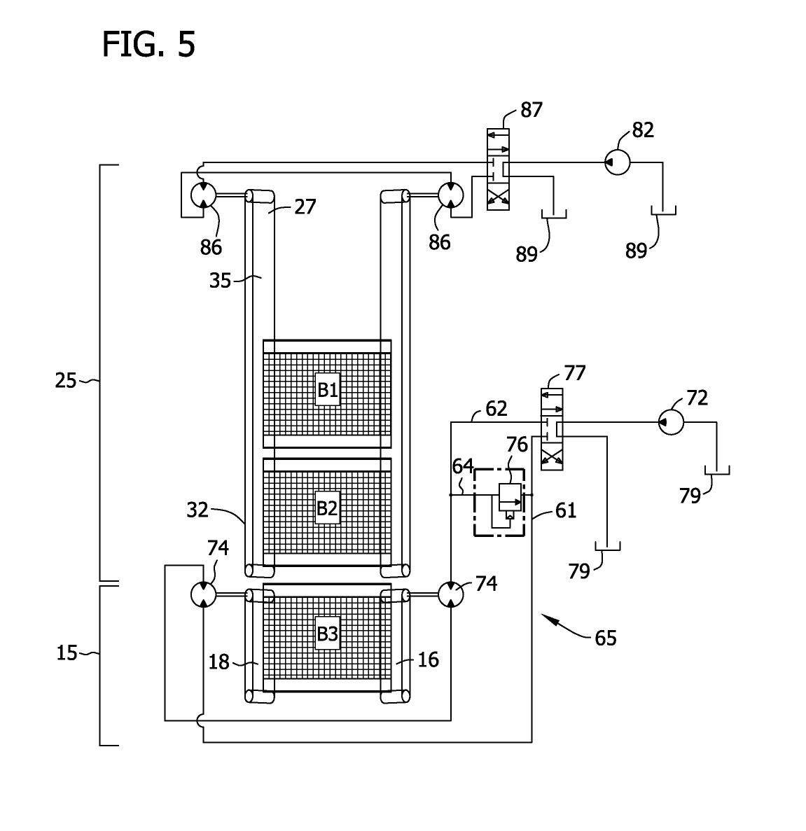

Alternatively and as shown in FIG. 5, the bed 25 may have one bed conveyor 35 on each side that extends from the first end 32 to the second end 27 rather than a series of bed conveyors on each side. In some embodiments, the bed 25 has a single conveyor belt (not shown) that forms a floor of the bed upon which the bales rest for moving bales toward the second end 27.

The conveyor belts 16, 18 of the first and second arms 4, 24 of the loading assembly 15 and the conveyor belts 35 of the bed 25 may be driven by hydraulics, as discussed above, or alternately by any type of rotary power device such as an electric motor. The position of the loading assembly 15 and bed 25 relative to the pull vehicle (i.e., whether the apparatus is pulled directly behind the pull vehicle or at an offset position such as when bales are being gathered from the field) may be adjusted by manipulating the angle between the tongue 1 and the bed chassis 6 (FIG. 1) by use of hydraulics or by any other suitable method.

The bed conveyors may be constructed from the same basic components used in the loading assembly conveyors, with an endless conveyor belt, an idler roller, a drive roller and supports. The embodiments illustrated herein show an alternative construction for the bed conveyors 35, each including an endless conveyor belt of a slightly different construction than the belts 16 and 18, routed around a drive pulley 62 and an idler pulley 62i. In some embodiments the drive pulley 62 is positioned at the front or, in other embodiments, at the rear.

The surface characteristics of the conveyors 16, 18 may affect the frictional engagement between the conveyor belt and the bale. The conveyor belts 16, 18 may include a surface that will adequately engage the bale to enhance the capability for the loading assembly to reliably lift the bales while also minimizing potential for damage to the bale and any bale wrapping.

It should be noted that any suitable type of conveyer belts or conveyor systems may be included in the apparatus. For instance, a conveyor belt composed of a carcass of nylon or fiberglass fibers covered by a wide variety of materials including rubber, PVC, thermoplastic polymer or the equivalent may be used. Chain conveyor systems may also be used without departing from the scope of the present disclosure. In this regard, “conveyor belt” as used herein includes any arrangement in which a belt, chain, track or the like is moved around a series of pulleys to cause movement of the belt, chain or track.

In operation, the apparatus 5 is pulled by the pull vehicle (not shown) toward a bale as shown in FIG. 3. The vehicle may provide the power for running the various conveyors and positioning systems (e.g., by use of hydraulics) or the apparatus 5 may include its own independent power system (e.g., hydraulic system). The apparatus 5 may be described herein with reference to a hydraulic system. It should be noted that the present disclosure should not be limited to a hydraulic system as the principles would apply to other power transfer technologies such as an electrical system.

As shown in FIG. 3, the bale B1 should be oriented such that the ends 40 of the cylindrical bale are perpendicular to the apparatus 5 as the apparatus 5 approaches the bale B1. The chassis 6 and tongue 1 are caused to be at an angle λ relative to one another such that the loading assembly 15 and bed 25 travel outside of the path of the pull vehicle (not shown) to allow the pull vehicle to travel “outside of” or parallel to the bales B targeted for loading.

The first and second conveyor belts 16, 18 are driven or actuated to cause the belt to move while the apparatus 5 travels toward the first bale B1. As the apparatus 5 approaches the bale B1, the conveyor belts 16, 18 of the arms 4, 24 contact the first bale causing the bale to be lifted and simultaneously moved toward the bed 25. The first bale B1 may be loaded onto the loading assembly 15 without stopping the apparatus 5 such that the apparatus 5 and the vehicle that pulls the apparatus may continually move forward during bale pick-up.

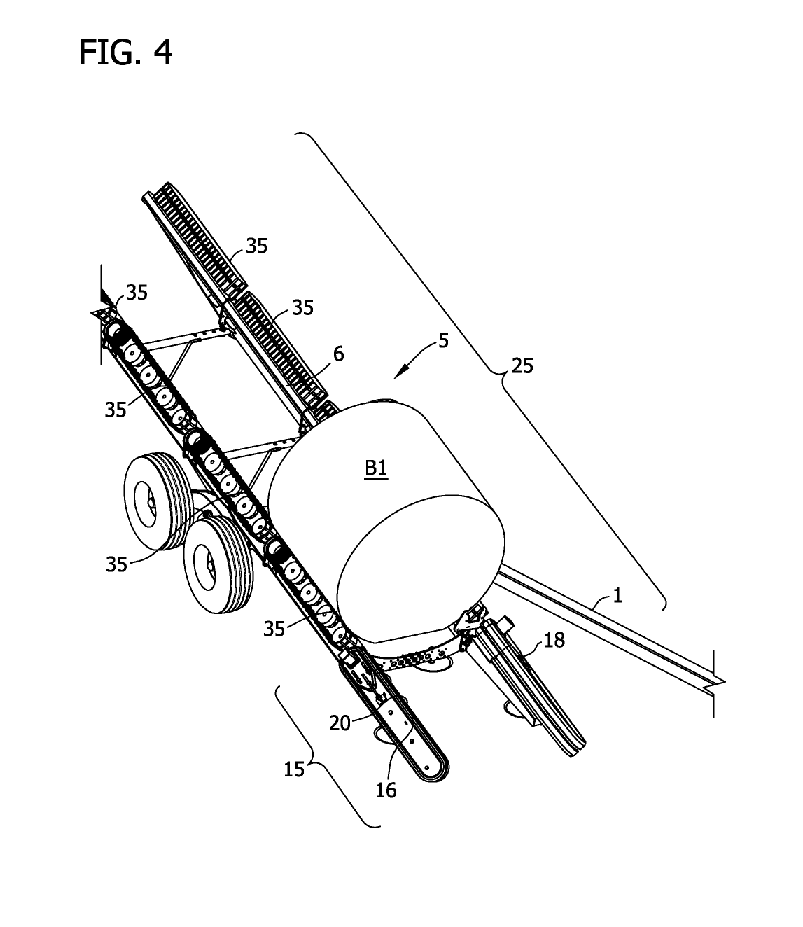

Once the bale B1 is loaded on the loading assembly 15, belt conveyors 35 (e.g., the set of conveyors nearest the loading assembly for the embodiment illustrated in FIG. 1, or the entire conveyor for the embodiment illustrated in FIG. 5) move to transfer the bale B1 from the loading assembly 15 to the position on the bed 25 as illustrated in FIG. 4. Once loaded onto the bed 25, the bed conveyors 35 are slowed or stopped to position the first bale B1 adjacent the end of the loading assembly.

In accordance with the present disclosure, each bale subsequent to the first bale B1 may be loaded until it contacts the previously loaded bale which causes the bale to stop. Once the first bale B1 is loaded, the apparatus 5 is directed to a second bale B2. The conveyor belts 16, 18 of the arms 4, 24 are in motion and contact the second bale B2 to cause the bale to move toward the bed 25 and toward the first bale B1. The loading assembly 15 grasps the second bale B2 and carries the second bale B2 toward the bed 25 until it contacts the first bale B1. Once the second bale B2 contacts the first bale B1, the conveyor belts 16, 18 of the loading assembly 15 are slowed or even stopped. One or more sets of bed conveyors 35 and conveyor belts 16, 18 of the loading assembly 15 are then actuated to move the first and second bales B1, B2 partially down the bed 25 toward the second end 27. This process is repeated to load additional bales.

The sequencing of bales in accordance with embodiments of the present disclosure may be further described with reference to FIG. 5 which shows a third bale B3 being loaded after loading of a first bale B1 and a second bale B2. It should be noted that the sequencing described with reference to FIG. 5 applies to each bale loaded subsequent to the first bale B1. After the second bale B2 is lifted and moved back onto the bed 25, the loading assembly 15 lifts and moves the third bale B3 toward the bed 25. The third bale B3 is allowed to contact the second bale B2. It should be noted that FIG. 5 is drawn, illustrating a small gap between the first bale B1 and the second bale B2 and between the second bale B2 and the third bale B3, in order to identify the different bales. However, the bales may be positioned in an abutting condition, where this gap would be minimized or eliminated.

Once the third bale B3 contacts the second bale B2, one or more sets of bed conveyors 35 and first and second conveyors 16, 18 of the loading assembly 15 are then caused to move and bales B1, B2, B3 travel partially down the bed 25 towards the second end 27, as a unit. Once the bed conveyors 35 advance, the first and second conveyors 16, 18 of the loading assembly 15 may automatically advance to allow the third bale B3 to retain its position adjacent the previously loaded bale. Once the third bale B3 is moved off of the loading device, the bed conveyors may slow or stop so that the end of the third bale B3 is held adjacent the loading assembly 15, ready to position the next bale B4.

In accordance with embodiments of the present disclosure, the apparatus 5 may include a hydraulic control system for controlling the transfer of bales from the loading assembly to the bed. Among other things, the control system controls transfer by controlling the first conveyor belt 16 and/or the second conveyor belt 18. The control system 65 for the loading assembly 15 and other portions of the hydraulic circuit for operating the loading assembly are shown schematically in FIG. 5. This Figure illustrates one example of a hydraulic circuit, in a simplified manner, using a type of hydraulic circuit known as an open center circuit. It should be noted that the principles of the open center circuit may also be implemented by those of skill in the art in other circuits such as a closed-center load-sensing circuit or closed-loop circuit without limitation.

The hydraulic circuit includes a pump 72 that pumps hydraulic fluid from a source of hydraulic fluid 79 (which may also be referred to herein as a “reservoir”) and that provides hydraulic pressure for operating hydraulic components (e.g., a hydraulic motor). The circuit also includes a spool valve 77. The spool valve 77 acts to direct hydraulic fluid back to the reservoir 79 or to one or more of the downstream hydraulic components. Spool valves may also be referred to in the art as “directional control valves.”

The reservoir 79, pump 72 and spool valve 77 may be integrated into the pulling vehicle rather than part of the control system of the apparatus 5. In such embodiments, the spool valve 77 may include female hydraulic couplers for connecting male couplers (not shown) of the control system 65 of the apparatus 5. In other embodiments, the hydraulic pump 72, spool valve 77 and reservoir 79 are separate and independent from the pulling vehicle.

The control system 65 of the apparatus 5 includes hydraulic motors 74 for rotating the drive rollers for the conveyor belts 16, 18. When movement of the conveyor belts 16, 18 is desired, the spool valve 77 is actuated to cause hydraulic fluid to travel to the motors 74. Hydraulic pressure causes the motors 74 to rotate which allows the conveyor belt to move. In this regard, any suitable arrangement of belts and pulleys may be used to attach the motors 74 to the drive rollers of the conveyor belts 16, 18.

A motor supply conduit 62 provides fluid communication between the hydraulic motors 74 and the source of hydraulic fluid 79 when the spool valve 77 is open. After hydraulic fluid passes through the motor 74, it is conveyed back through the spool valve 77 to the source of hydraulic fluid 79 through motor return conduit 61.

The control system 65 also includes a hydraulic relief valve 76. A relief valve supply conduit 64 is in fluid communication with the motor supply conduit 62 and the relief valve 76. The relief valve 76 is configured or programmed to open when the pressure in the control system reaches a pre-set relief pressure. Upon opening, hydraulic fluid passes from the relief valve supply conduit 64, through the relief valve 76 and to the motor return conduit 61, by-passing the motors 74. When fluid flows through the relief valve 76, fluid pressure equal to the pre-set relief pressure is maintained in the motor supply conduit 62 and applied to the motors 74. This allows the motors 74 to slow or stop moving while maintaining torque.

During loading of a bale the hydraulic motor 74 is powered by the hydraulic pressure which causes conveyor belts 16, 18 (FIG. 4) to move to cause the bale to move toward the previously loaded bale(s). The hydraulic pressure in the motor supply conduit 62 during this initial lifting and moving phase has been found to be less than the pre-set relief pressure so the oil flow is forced through the motors. Once the bale being loaded contacts the previously loaded bale(s) the pressure in the motor supply conduit 62 and relief valve supply conduit 64 increases. The relief valve 76 opens once a minimum pressure is achieved which causes the conveyor belts 16, 18 to slow or even stop rotating. The relief valve 76 prevents the conveyor belts 16, 18 from continuing to move after the bale being loaded contacts the previously loaded bale. This prevents the conveyor belts 16, 18 from slipping relative to the bale and thereby prevents damage to the bale.

If the relief valve 76 was not present in this circuit, the pressure may continue to increase thereby increasing the torque produced by the motor and the force that the conveyor belts apply to the bale until the static friction between the conveyor belt and bale was exceeded. At that pressure (i.e., Pₛₗᵢₚ), the belt would begin to slip relative to the bale which would result in damage to the bale. The pre-set relief pressure of the valve 76 can be set at a pressure that is less than Pₛₗᵢₚ so that the motors 74 slow or stop and oil by-passes through the relief valve 76 to avoid damaging the bales.

The hydraulic circuit shown in FIG. 5 may include other components or parts including oil coolers, other relief valves and oil filters. In this regard, it should be understood that use of the term “conduit” herein is not meant to imply direct transfer from one unit of the hydraulic circuit to another but rather includes indirect transfer, e.g., the hydraulic fluid may be transferred from one unit to another by any number of transfer parts and/or mechanisms. Each part including the intermediate parts themselves may be considered to form at least a portion of the “conduit” and the phrase “conduit” should not be construed in a limiting sense.

The hydraulic control system 65 may be used to control the first conveyor belt 16 and the second conveyor belt 18 as shown. In other embodiments, the second conveyor belt 18 may be controlled by a separate control system (not shown). The second control system may be fluidly connected to the relief valve 76 or may include a separate relief valve. The second control system may also share other parts of the first control system (e.g., one or more conduits).

In embodiments wherein the second control system includes a second relief valve (not shown) for control of the second conveyor belt 18, each conveyor belt 16, 18 is able to slow or stop independent of the other conveyor belt when loading bales. This allows a bale that is loaded onto the arms 4, 24 at an angle (i.e., when the flat ends 40 (FIG. 3) of the bale are not perpendicular to the apparatus 5) to be made square with the bales that are previously loaded on the bed 25. In such embodiments, one side of the skewed bale being loaded contacts a previously loaded bale causing the conveyor belt to slow or stop on that side of the apparatus. The conveyor belt on the opposing side may continue to move until the skewed bale fully contacts the previously loaded bale causing the flat ends 40 to become perpendicular to the apparatus 5.

In this regard, while the control system 65 described above may be used in connection with an apparatus configured for loading round bales, in other embodiments the apparatus may be configured to gather small square or large square bales, or any packages where it is desirable to position the packages in an abutting condition, while automatically minimizing potential damage that can be caused by slippage between the package and a conveyor, without limitation.

As shown in FIG. 5, the apparatus may include one or more separate hydraulic circuits for rotating the bed conveyors. Each bed conveyor hydraulic circuit may include a source of hydraulic fluid 89, pump 82, spool valve 87 and hydraulic motors 86 for rotating the bed conveyors 35. In this regard, it should be noted that the pump 82 and spool valve 87 may be part of the pulling vehicle and not the gathering apparatus. The bed conveyor hydraulic circuit may also include a hydraulic relief valve similar to relief valve 76 that is configured to actuate in response to an increase in hydraulic pressure to slow or stop movement of the bed conveyor. In this regard, a control system similar to control system 65 (e.g., a system in including a relief valve 76) may be used to control bed conveyors 35 through hydraulic motors 86. Such a control system may be useful during unloading of bales (from the front or back) as bales may be pushed off the bed conveyors 35 without the conveyors 35 slipping beneath partially unloaded bales.

The bed conveyors 35 may operate once the bale being loaded contacts the previously loaded bale to cause the bales to move in the direction of the second end 27 of the bed.

Bales may continue to be loaded onto the apparatus 5 until the apparatus becomes fully loaded. Once fully loaded, the apparatus 5 may be adjusted to promote ease of travel to the unloading site. As shown in FIG. 6, the bed chassis 6 of the apparatus 5 may be leveled by use of hydraulic cylinder 17 (FIG. 2) and the tongue 1 and the relative position between tongue 1 and the bed 15 may be adjusted (e.g., the tongue may be adjusted to be more parallel to the bed).

As shown in FIG. 7, once the apparatus 5 is pulled to the desired unloading site for the bales, the bed chassis 6 is tilted by use of the hydraulic cylinder 17 (FIG. 2). The bed conveyors 35 are operated and the apparatus 5 is caused to move forward while the bales are unloaded. Alternatively, the apparatus 5 may be caused to move backwards such that bales are unloaded from the loading assembly 15. In embodiments in which bales are unloaded in this manner, the bales may be unloaded such that each successive bale touches the previously unloaded bale (i.e., the conveyors 16, 18 may travel faster than ground speed) without slipping the conveyor belts 16, 18 and damaging the bales by use of a relief valve.

Compared to conventional apparatus for gathering bales, the apparatus 5 described above has several advantages. By using one or more relief valves 76 (FIG. 5) the first and conveyor belts 16, 18 may slow or stop rotating upon contact between the bale being loaded and previously loaded bales. This prevents the conveyor belts from slipping relative to the bale being loaded and thereby inhibits or prevents damage to the bale. In embodiments wherein the hydraulics for each conveyor belt 16, 18 include separate relief valves 76, the orientation of a bale that has started to be loaded in a skewed orientation (relative to the apparatus and other bales) may be corrected so that the orientation is aligned with the apparatus and the other bales.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1. An apparatus for gathering bales, the apparatus comprising:
a bed for holding a plurality of bales;
a loading assembly for lifting a bale and conveying it to the bed, the loading assembly comprising:
a first arm comprising a first conveyor belt; and
a second arm comprising a second conveyor belt; and
a control system for regulating transfer of bales from the loading assembly to the bed by control of the first conveyor belt and/or the second conveyor belt, the control system comprising:
a hydraulic motor for rotating the first conveyor belt and/or the second conveyer belt; and
a hydraulic relief valve configured to actuate in response to an increase in hydraulic pressure to slow or stop movement of the first conveyor belt and/or the second conveyer belt.

2. The apparatus as set forth in claim 1 comprising:
a motor supply conduit in fluid communication with the hydraulic motor and capable of being in fluid communication with a source of hydraulic fluid; and
a hydraulic relief valve supply conduit in fluid communication with the motor supply conduit and the relief valve.

3. The apparatus as set forth in claim 2 comprising:
a motor return conduit in fluid communication with the hydraulic motor and capable of being in fluid communication with the source of hydraulic fluid; and
a hydraulic relief valve return conduit in fluid communication with the valve and capable of being in fluid communication with the source of hydraulic fluid.

4. The apparatus as set forth in claim 3 wherein the relief valve return conduit is in fluid communication with the motor return conduit.

5. The apparatus as set forth in claim 1 wherein the hydraulic assembly comprises a second hydraulic motor, the first hydraulic motor being connected to a first drive roller for movement of the first conveyor belt and the second hydraulic motor being connected to a second drive roller for movement of the second conveyor belt.

6. The apparatus as set forth in claim 5 wherein the hydraulic relief valve is capable of actuating in response to an increase in hydraulic pressure to slow or stop movement of the first conveyor belt and the second conveyer belt.

7. The apparatus as set forth in claim 5 comprising a second control system for regulating transfer of bales from the loading assembly to the bed by control of the second conveyor belt, the control system comprising:
a second hydraulic motor for rotating the second conveyor belt; and
a second hydraulic relief valve that is capable of actuating in response to an increase in hydraulic pressure to slow or stop movement of second conveyer belt.

8. The apparatus as set forth in claim 1 comprising:
a bed conveyor for moving bales on the bed; and
a control system for regulating transfer of bales from the loading assembly to the bed by control of the bed conveyor, the control system comprising:
a hydraulic motor for rotating the bed conveyor; and
a hydraulic relief valve configured to actuate in response to an increase in hydraulic pressure to slow or stop movement of the bed conveyor.

9. An apparatus for gathering bales, the apparatus comprising:
a bed for holding a plurality of bales, the bed comprising a bed conveyor; and
a control system for regulating the bed conveyor, the control system comprising:
a hydraulic motor for rotating a bed conveyor; and
a hydraulic relief valve configured to actuate in response to an increase in hydraulic pressure to slow or stop movement of the bed conveyor.

10. The apparatus as set forth in claim 9 comprising:
a motor supply conduit in fluid communication with the hydraulic motor and capable of being in fluid communication with a source of hydraulic fluid; and
a hydraulic relief valve supply conduit in fluid communication with the motor supply conduit and the relief valve.

11. The apparatus as set forth in claim 10 comprising:
a motor return conduit in fluid communication with the hydraulic motor and capable of being in fluid communication with the source of hydraulic fluid; and
a hydraulic relief valve return conduit in fluid communication with the valve and capable of being in fluid communication with the source of hydraulic fluid.

12. The apparatus as set forth in claim 11 wherein the relief valve return conduit is in fluid communication with the motor return conduit.

13. The apparatus as set forth in claim 9 comprising:
a second bed conveyor; and
a control system for regulating the second bed conveyor, the control system comprising:
a hydraulic motor for rotating a bed conveyor; and
a hydraulic relief valve configured to actuate in response to an increase in hydraulic pressure to slow or stop movement of the bed conveyor.

14. A method for gathering bales on an apparatus having a bed for holding a plurality of bales and a loading assembly for lifting a bale and conveying it to the bed, the method comprising:
loading a first bale on the bed;
contacting a second bale using a first conveyor belt of a first arm of the loading assembly and a second conveyor belt of a second arm of the loading assembly;
actuating the first and second conveyor belts to cause the second bale to move toward the first bale; and
slowing or stopping movement of the first conveyor belt and/or second conveyor belt when the second bale contacts the first bale.

15. The method as set forth in claim 14 wherein the apparatus comprises a control system for regulating transfer of bales from the loading assembly to the bed by control of the first conveyor belt and/or the second conveyor belt, the control system comprising a hydraulic motor and a hydraulic relief valve wherein:
actuating the first and second conveyor belts includes actuating the hydraulic motor; and
slowing or stopping movement of the first and second conveyor belts includes actuating the hydraulic relief valve in response to increasing pressure in the control system.
